(19) United States
(12) Patent Application Publication
(10) Pub. No.: US 2009/0020367 A1
(43) Pub. Date: Jan. 22, 2009

(54) Oil Pan Structure for Internal Combustion Engine

(75) Inventor: Takahiro Kawashima, Chiryu-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/223,445

(22) PCT Filed: Feb. 21, 2007
(86) PCT No.: PCT/IB2007/000495

§ 371 Date: Jul. 31, 2008

(30) Foreign Application Priority Data
Feb. 21, 2006 (JP) 2006-044170

(51) Int. Cl. F16N 31/00

(52) U.S. Cl. 184/106; 123/196 R

(57) ABSTRACT

An oil pan structure for an internal combustion engine includes an oil pan and a baffle plate provided inside the oil pan having a storage section for collecting oil that is returned after circulating through the engine to lubricate and cool the engine. The storage section has a generally flat bottom with a generally rectangular shape as viewed in a plan view, and front, left, and right side walls that extend upward from the bottom. The storage section also has an oil drain port through which the oil in the storage section is drained into the oil pan. The opening of oil drain port is near and faces a wall of the oil pan.

### BACKGROUND OF THE INVENTION

1. Field of the Invention

The present invention relates to an oil pan structure for an internal combustion engine, and, more particularly, to an oil pan structure that reduces the frothing of the oil stored in the oil pan.

2. Description of the Related Art

In general, an oil pump is driven by rotation of a crankshaft to draw oil collected in an oil pan through a strainer and send the oil to every part of the internal combustion engine under pressure. The oil that has been used to lubricate and cool every part of the internal combustion engine is returned to the oil pan and circulated again. When oil returning to the oil pan falls onto the surface of the oil collected in the oil pan, air bubbles are generated in the collected oil. When oil containing air bubbles is drawn into the strainer, the oil pump may vibrate or the insufficient oil may be supplied to parts of the engine.

To address this problem, a conventional internal combustion engine is described in, for example, JP-A-2005-120879, as having an oil pan structure having an oil pan that is provided with a partition that divides the space in the oil pan into an inlet from which oil is drawn into a strainer and a drop port into which returning oil falls from above; and an oil guide located above the oil pan that receives the returning oil and guides the oil to a drop port. The oil guided by the oil guide is allowed to fall into the drop port in the oil pan and directed from the drop port to an inlet inside the partition through a long passage and an opening formed through a lower part of the partition so that air bubbles contained in the oil in the oil pan can decrease with the lapse of time during which the oil flows through the long passage from the drop port to the inlet in order to reduce the bubble content in the oil to be drawn into the strainer.

The bubble content in the oil in the oil pan decreases with the lapse of time during which the oil flows through the long passage from the drop port to the inlet. However, the measure described above is still insufficient to reduce the frothing of the oil in the oil pan effectively because frothing continually occurs in the oil collected in the oil pan when returning oil falls into the drop port in the oil pan.

Another reference describes an internal combustion engine having an oil pan structure in which a baffle plate is provided in the oil pan. In this internal combustion engine, however, because oil drained through a plurality of oil drop ports opening through the baffle plate falls onto the oil surface in the oil pan, frothing still occurs in the oil in the oil pan by the oil falling onto the oil surface in the oil pan. It has the same problem.

### SUMMARY OF THE INVENTION

The present invention provides an oil pan structure for an internal combustion engine with which the bubble content in the oil in an oil pan can be decreased effectively.

In one aspect of the present invention, an oil pan structure for an internal combustion engine has an oil pan and a baffle plate provided inside the oil pan, in which the baffle plate has a storage section for collecting returning oil and an oil drain port through which the oil in the storage section is drained into the oil pan. An opening of the oil drain port is near and faces a wall of the oil pan.

According to the above aspect, the returning oil, which has been used to lubricate and cool every part of the internal combustion engine, does not directly fall onto the oil surface in the oil pan but is received in the storage section of the baffle plate, and air bubbles are eliminated from the oil temporarily stored in the storage section. In addition, because the oil temporarily stored in the storage section is drained through the oil drain port, which opens near and faces a rear wall of the oil pan, and along the wall of the oil pan, frothing that occurs in an engine in which oil falls directly onto the oil surface in the oil pan is eliminated. Because no frothing occurs when oil is drained onto the oil surface in the oil pan, the bubble content in the oil in the oil pan is effectively decreased.

In the above aspect, the storage section of the baffle plate may have a generally flat bottom having a generally rectangular shape and walls extending upward from three of the four sides of the bottom, and the oil drain port may be formed at the remaining side of the four sides. In this case, the oil temporarily stored in the storage section is drained smoothly through the oil drain port, which opens at one side of the bottom, and along a wall of the oil pan. Because frothing is effectively prevented when oil is drained onto the oil surface in the oil pan, the bubble content in the oil in the oil pan is effectively decreased.

In the above aspect, the bottom of the baffle plate may contact the oil surface in the oil pan. In this case, during operation of the internal combustion engine the oil surface in the oil pan may ruffles; however, the ruffling is prevented because of the contact with the bottom of the baffle plate, and frothing caused by ruffling of the oil surface is prevented.

In the above aspect, the bottom of the baffle plate may be inclined with respect to the oil surface in the oil pan in the longitudinal direction of the internal combustion engine. In this case, the oil surface in the oil pan easily comes into contact with the bottom of the baffle plate even when the level of the oil surface is varied depending on the engine rotational speed and the amount of oil collected in the oil pan during the operation of the engine. Therefore, ruffling of the oil surface in the oil pan is effectively prevented when the engine is operating, and frothing caused by ruffling of the oil surface is efficiently prevented.

In addition, in the above aspect, the bottom of the baffle plate may have an oil outlet port that opens on the side of the baffle plate opposite the oil drain port. In this case, oil is smoothly drained into the oil pan through the oil outlet port even in a driving situation in which the oil in the storage section of the baffle plate is less likely to be drained into the oil pan through the oil drain port (during turning, for example). Therefore, the drawing of air into the strainer caused by a shortage of oil in the oil pan is effectively prevented. In addition, in a normal driving situation in which the oil in the storage section of the baffle plate is smoothly drained into the oil pan through the oil drain port, oil with a relatively high bubble content in the storage section is drained through the oil drain port whereas oil with a relatively low bubble content accumulated at the bottom of the storage section is drained through the oil outlet port. Therefore, the bubble content in the oil in the oil pan is decreased while eliminating a shortage of oil stored in the oil pan.

As described above, because the oil drain port, through which the oil in the storage section of the baffle plate is drained into the oil pan, is near and faces a wall of the oil pan, the returning oil, which has been used to lubricate and cool every part of the internal combustion engine, does not fall directly onto the oil surface in the oil pan, but is received in the storage section. Therefore, air bubbles in the oil is eliminated. In addition, the oil temporarily stored in the storage section is drained through the oil drain port into the oil pan along a wall thereof to prevent frothing. Therefore, the bubble content in the oil in the oil pan is effectively decreased.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a cross-sectional view of an engine having an oil pan structure according to an embodiment of the present invention, viewed from the front side.

FIG. 2 is an exploded perspective view illustrating the manner in which a baffle plate is attached to a ladder frame.

FIG. 3 is a vertical cross-sectional side view showing the baffle plate, an oil strainer, and an oil pan attached to the ladder frame.

FIG. 4 is a plan view of the baffle plate.

FIG. 5 is a cross-sectional view of the baffle plate taken along the line V-V of FIG. 4.

### DETAILED DESCRIPTION OF THE PREFERRED EMBODIMENTS

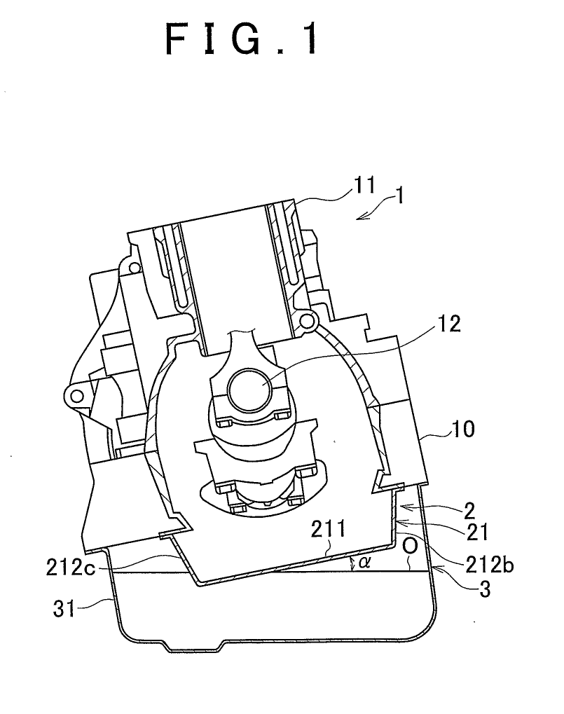

FIG. 1 shows an example in which an oil pan structure according to the embodiment of the present invention is applied to an inline four-cylinder engine. A ladder-shaped ladder frame 10 is attached to a lower surface of a cylinder block 11 of an engine 1. A crankshaft 12 is rotatably supported between the ladder frame 10 and the cylinder block 11. In this case, one end of the crankshaft 12 is located on the front side of the engine 1, and the other end of the crankshaft 12 is located on the rear side of the engine 1. In other words, the axial direction of the crankshaft 12 coincides with the longitudinal direction of the engine 1.

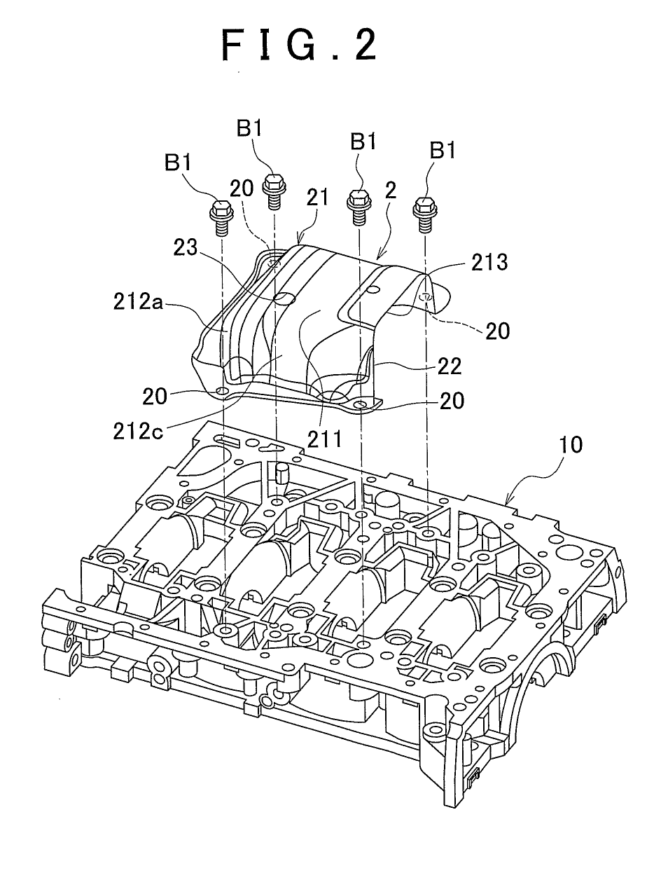

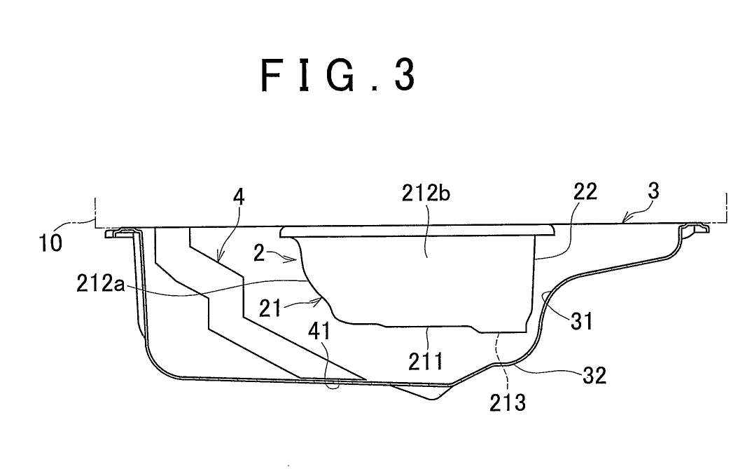

As shown in FIG. 2, a baffle plate 2 having a generally rectangular shape as viewed in a plan view is secured to approximately the center of the lower surface of the ladder frame 10 by bolts B1 extending through bolt holes 20 at four corners thereof. The peripheral edge of an oil pan 3 is attached to the outer peripheral edge of the lower surface of the ladder frame 10 such that the baffle plate 2 is covered with the oil pan 3. In addition, as shown in FIG. 3, a base portion of an oil strainer 4 is attached to a front part (left side in FIG. 3) of the lower surface of the ladder frame 10. The oil strainer 4 extends downward along the front side of the baffle plate 2, and has a suction port 41 at its distal end located at the bottom of the oil pan 3. In this case, the oil strainer 4 is attached to a front part of the lower surface of the ladder frame 10 with the baffle plate 2 secured to the lower surface of the ladder frame 10, and the oil pan 3 can be attached to the outer peripheral edge of the lower surface of the ladder frame 10 in this state. Thus, the baffle plate 2, the oil pan 3, and the oil strainer 4 can be easily attached to the lower surface of the ladder frame 10.

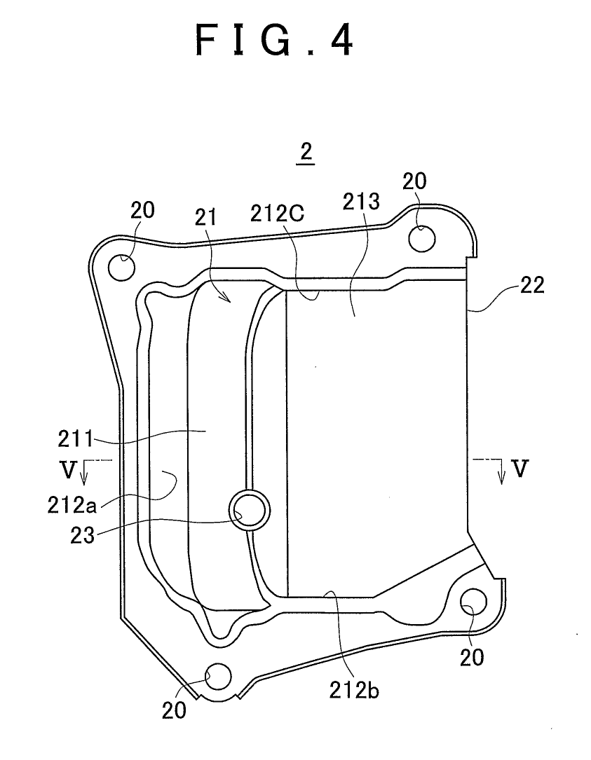

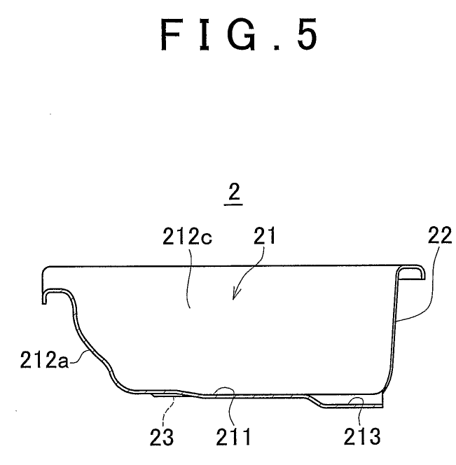

As shown in FIG. 4 and FIG. 5, the baffle plate 2 has a storage section 21 for collecting returning oil. The storage section 21 has a generally flat bottom 211 having a generally rectangular shape as viewed in a plan view, and front, left, and right side walls 212a, 212b, and 212c extending upward from the front, left, and right sides, respectively, of the bottom 211 among the four sides (front, rear, right, and left sides) thereof and surrounding the bottom 211 from outside. That is, the bottom 211 extends generally parallel to the longitudinal direction of the engine 1, and the portions of the side walls 212a, 212b, and 212c that connect to the bottom 211 are inclined toward the inside of the storage section 21. The storage section 21 has an oil drain port 22 that opens to the rear of the bottom 211. The oil collected in the storage section 21 is drained through the oil drain port 22 into the oil pan 3. A guide portion 213 is formed for smoothly guiding the oil in the storage section 21 toward the oil drain port 22 by recessing a rear part of the bottom 211 of the storage section 21. A lower part of the oil drain port 22 opens at a position near and facing the rear wall 31 of the oil pan 3. A portion 32 of the bottom of the oil pan that is located below the oil drain port 22 of the baffle plate 2 is closer to the oil drain port 22 than portions of the bottom of the oil pan that are not located below the oil discharge port 22.

The bottom 211 of the baffle plate 2 contacts the oil surface (O) in the oil pan 3, as shown in FIG. 1, even when the engine 1 is operating. The bottom 211 of the baffle plate 2 is inclined by a predetermined angle a with respect to the oil surface (O) in the oil pan 3 as viewed in the longitudinal direction of the engine 1.

Also, the bottom 211 of the baffle plate 2 has an oil outlet port 23 that opens downward at a position near the front of the baffle plate (the front side wall 212a) opposite the oil drain port 22 as shown in FIG. 4 and FIG. 5.

Therefore, in the above embodiment, the returning oil from above does not directly fall onto the oil surface (O) in the oil pan 3 but is received in the storage section 21 of the baffle plate 2 and air bubbles are eliminated from the oil temporarily collected in the storage section 21. In addition, because the oil temporarily collected in the storage section 21 is drained through the oil drain port 22, which opens at the rear side of the bottom 211, near and facing the rear wall 31 of the oil pan 3, and along the wall 31 of the oil pan 3, continuous frothing due to oil falling directly onto the oil surface (O) in the oil pan 3 is prevented. Because frothing is prevented, the bubble content in the oil in the oil pan 3 is effectively decreased.

Also, because the bottom 211 of the baffle plate 2 contacts the oil surface (O) in the oil pan 3 even when the engine 1 is operating, ruffling of the oil surface (O) in the oil pan 3 is prevented, and which prevents frothing caused by ruffling of the oil surface (O).

In addition, because the bottom 211 of the baffle plate 2 is inclined with respect to the oil surface (O) in the oil pan 3 as viewed in the longitudinal direction of the engine 1, the oil surface (O) in the oil pan 3 can easily contact the bottom 211 of the baffle plate 2 even when the level of the oil surface (O) is varied depending on the engine rotational speed and the amount of oil collected in the oil pan 3 during the operation of the engine 1. Therefore, ruffling of the oil surface (O) in the oil pan 3 is effectively prevented even when the engine 1 is operating, and generation of air bubbles caused by ruffling of the oil surface (O) is efficiently prevented.

Moreover, because the oil outlet port 23 opens to the oil pan 3 at a position close to the front of the bottom 211, opposite where the oil drain port 22 opens, oil is smoothly drained into the oil pan 3 through the oil outlet port 23 even in a driving situation in which the oil collected in the storage section 21 of the baffle plate 2 is less likely to be drained into the oil pan 3 through the oil drain port 22 (during turning, for example). Therefore, by preventing a shortage of oil stored in the oil pan 3, air is not drawn into the strainer 4. In addition, in a normal driving situation in which the oil collected in the storage section 21 of the baffle plate 2 is smoothly drained into the oil pan 3 through the oil drain port 22, oil with a relatively high bubble content in the storage section 21 is drained through the oil drain port 22 whereas oil with a relatively low bubble content accumulated at the bottom of the storage section 22 is drained through the oil outlet port 23. Therefore, the bubble content in the oil in the oil pan 3 can be decreased while eliminating a shortage of oil stored in the oil pan 3.

The present invention is not limited to the above embodiment and includes other various modifications. For example, while the oil pan structure described is applied to an inline four-cylinder engine in the above embodiment, the present invention may be applied to other engines for vehicles such as inline six-cylinder engines and V-type engines.

1. An oil pan structure for an internal combustion engine, comprising:
an oil pan; and
a baffle plate provided inside the oil pan, wherein:
the baffle plate has a storage section for collecting returning oil and an oil drain port through which the oil in the storage section is drained into the oil pan;
an opening of the oil drain port is near and faces a wall of the oil pan;
the storage section of the baffle plate has a generally flat bottom having a generally rectangular shape and walls extending upward from three sides of the bottom of the baffle plate, leaving one side open;
the oil drain port is formed at the open side of the bottom; and
the bottom of the baffle plate has an oil outlet port opening at a position opposite the opening of the oil drain port.

2. The oil pan structure according to claim 1, wherein portions of the walls connected to the bottom of the baffle plate are inclined toward the inside of the storage section.

3. The oil pan structure according to claim 1, wherein the bottom of the baffle plate contacts an oil surface in the oil pan.

4. The oil pan structure according to claim 3, wherein the bottom of the baffle plate is inclined with respect to the oil surface in the oil pan in a longitudinal direction of the internal combustion engine.

5. The oil pan structure according to claim 1, wherein the bottom of the baffle plate is positioned generally parallel to a longitudinal direction of the internal combustion engine.

6. The oil pan structure according to claim 5, wherein the longitudinal direction of the internal combustion engine coincides with an axial direction of a crankshaft of the internal combustion engine.

7. The oil pan structure according to claim 1, wherein the baffle plate has a guide portion that guides the oil in the storage section toward the oil drain port.

8. The oil pan structure according to claim 1, wherein a portion of a bottom of the oil pan that is located below the oil drain port of the baffle plate is formed closer to the oil drain port than portions of the bottom of the oil pan that are not located below the oil drain port.

9. The oil pan structure according to claim 4, wherein the longitudinal direction of the internal combustion engine coincides with an axial direction of a crankshaft of the internal combustion engine.
